(19) United States
(12) Patent Application Publication
(10) Pub. No.: US 2006/0199004 A1
(43) Pub. Date: Sep. 7, 2006

(54) Electroconductive adhesive tape

(75) Inventor: Yong-In Lee, Seoul (KR)

Correspondence Address: EGBERT LAW OFFICES, 412 MAIN STREET, 7TH FLOOR, HOUSTON, TX, 77002, US

(73) Assignee: SHINWHA INTERTEK Corp., Hwasung-Gun (KR)

(21) Appl. No.: 11/403,278

(22) Filed: Apr. 13, 2006

Related U.S. Application Data
(63) Continuation-in-part of application No. 10/404,909, filed on Apr. 2, 2003.
Application No. 10/404,909 is a continuation-in-part of application No. 09/866,217, filed on May 29, 2001, now abandoned.

(30) Foreign Application Priority Data
Mar. 29, 2001 (KR) 2001-16409

(51) Int. Cl. B32B 7/12

(52) U.S. Cl. 428/344; 428/354

(57) ABSTRACT

An electroconductive adhesive tape used for electrical and electronic products to bond or fix an element to a support while maintaining an electrical conductivity between the element and support. The electroconductive adhesive tape includes a perforated synthetic film, two metal plating layers respectively formed on both surfaces of the synthetic resin film, and a conductive adhesive layer formed on one of the metal plating layers. Made to be very thin, the film has the advantage of being flexible and high in tensile strength in addition to showing excellent electrical conductivity. The metal plating layers are integratedly formed through the perforations of the synthetic resin film, maintaining excellent electrical conductivity. Thus, the electroconductive adhesive tape maintains a desired strength while exhibiting a high flexibility and a high bondability.

### RELATED U.S. APPLICATIONS

The present application is a continuation-in-part of U.S. application Ser. No. 10/404,909, filed on Apr. 2, 2003, and entitled ELECTROCONDUCTIVE ADHESIVE TAPE”, presently pending. The '909 application is a continuation-in-part of U.S. application Ser. No. 09/866,217, filed on May 29, 2001.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to an electroconductive adhesive tape comprising a perforated synthetic film on both surfaces of which two metal plate layers are deposited, one of them being coated with a conductive adhesive layer. Electroconductive adhesive tapes have numerous applications in a broad range of technical fields associated with electrical and electronic products to bond or fix an element to a support while maintaining an electrical conductibility between the element and support.

### BACKGROUND OF THE INVENTION

Electroconductive adhesive tapes, for example, are usually used in assembling processes for video display appliances such as televisions. In this case, they serve to fix the Braun tube of the television, as well as to ground electrostatic charge and electromagnetic fields accumulatively induced on the outer peripheral surface of the Braun tube, thereby removing the electrostatic charge and electromagnetic fields. Another field to which such electroconductive adhesive tapes are applied is the assemblage of cars and electronic products.

On the whole, a Braun tube comprises an evacuated bulb made of glass, so that it is susceptible to an external impact. For this reason, such a Braun tube is not directly fixed to a casing or housing, but to the casing or housing through a bracket bonded adhesively to the outer peripheral surface of the Braun tube.

In addition to being used in bonding the bracket to the Braun tube, adhesive tapes have a buffering function to prevent the Braun tube from being damaged. Even in the case that the Braun tube explodes due to a severe external impact or other accident, the adhesive tape reduces the flying range of pieces of broken glass.

For this reason, an adhesive tape adapted to fix a bracket to a Braun tube is called an explosion-proof tape. Electrical conductivity provided to such an explosion-proof tape is necessary to additionally prevent electrostatic charge and electromagnetic fields induced on the outer peripheral surface of the Braun tube from being outwardly emitted. To meet the requirement of high tensile strength for such an explosion-proof tape, the base material for the tape adopts a glass fiber net structure.

A very high voltage is applied to the inner surface of a Braun tube used in video display appliances, such as televisions, so as to form an image on that inner surface. As a result, the application of such a very high voltage induces electrostatic charge on the outer surface of the Braun tube. Unless the generated electrostatic charge is removed, the charge is accumulates, forming a magnetic field and an electric field. As a result, electromagnetic waves are outwardly emitted from the Braun tube.

In order to prevent an accumulation of electrostatic charge induced on the Braun tube and to shield electromagnetic waves emitted from the Braun tube, various techniques have been proposed, one of which is to use an electrically conductive adhesive tape to remove the accumulated electrostatic charge via an earth circuit, as illustrated in FIG. 1.

When a Braun tube is assembled, an electroconductive adhesive tape is used to fix the Braun tube directly to an iron bracket. In this regard, an elongated, electroconductive adhesive tape is cut into pieces having a desired length. The conductive adhesive tape pieces are bonded to the outer peripheral surface of a Braun tube while being spaced from one another. An iron bracket 4 is then bonded to the outer peripheral surface of the Braun tube via the conductive adhesive tape pieces while being electrically connected to the conductive adhesive tape pieces. Thus, electrostatic charge induced on the Braun tube is discharged via the bracket to an earth circuit 3 equipped in a cabinet.

Referring to FIG. 2, there is shown a structure of an electroconductive adhesive tape which is typically used for the above mentioned purpose. As shown in FIG. 2, the conductive adhesive tape comprises a conductive metal foil 11, such as copper or aluminum, a conductive adhesive layer 10, and a strippable protective sheet 12. The conductive adhesive tape is used after stripping the protective sheet therefrom.

As shown in FIG. 1, the Braun tube can be divided into several sections. One of them is a display panel section 1 having a conductive surface on its inner surface to display an image. The conductive surface is formed by coating a conductive material 2 such as carbon or conductive ceramic onto the surface of the display panel section 1 using a vapor deposition technique, a sputtering technique or an ion plating technique. Another section comprises a deflection yoke made of an electromagnet, which serves to stabilize an electron beam emitted from the electron gun 9. Around this section, a funnel-shaped metal sheet 8 is mounted in order to shield the electromagnetic waves. Also, electroconductive adhesive tape 7 is attached to desired portions of the remaining outer surface of the Braun tube in order to prevent an accumulation of electrostatic charge induced on the Braun tube and an emission of electromagnetic waves from the Braun tube.

Returning now to FIG. 1, the reference numeral 3 stands for an earth circuit, the reference numeral 4 for an iron bracket, and the reference numeral 5 for a silicon resin layer to insulate the outer surface of the Braun tube from a high-voltage current flowing from an anode denoted by the reference numeral 6. The reference numeral 16 denotes an explosion-proof tape.

For use in the assemblage of Braun tubes, electroconductive adhesive tapes are required to be thin and high in tensile strength, and flexible. That is, the electroconductive adhesive tapes are not able to be destroyed easily, but are able to maintain a good appearance after assemblage. Flexibility is necessary for the tape to show a uniform surface bonding to a curved surface.

A conventional electroconductive tape is structured to have a conductive metal strip, such as aluminum foil or copper foil, attached to a conductive adhesive layer and optionally is subjected to a release process so that it can be rolled without using any strippable protective sheet.

The term “electroconductive or conductive adhesive” as used herein means an adhesive which is prepared by mixing a conductive metal powder with an adhesive material produced by dissolving rubber or an acrylic resin in an organic solvent, and thus exhibiting appropriate conductivity determined according to the added amount of the conductive metal powder.

Examples of the conductive metal powder include copper, aluminum, nickel, chromium, and graphite. The conductive metal powder has a size of 2-5 μm and is added at an amount of about 50 to 200 parts by weight based on 100 parts by weight of the adhesive material.

Conventional conductive adhesive tapes that are structured to have a metal foil layer and a conductive adhesive layer are so poor in flexibility and elongation that they are likely to crumple and tear. Additionally, their poor flexibility lowers the bondability of the conventional conductive adhesive tapes to curved portions.

Since the above-mentioned conventional metal foil has a relatively large thickness of about 20 to 65 μm, it is likely to crumple when being bonded to the iron bracket, which, in turn, results in a poor surface bonding. Furthermore, the tape exhibits a degraded flexibility due to the large thickness of the metal foil. In order to obtain a uniform surface bonding of the tape to a curved surface, it is necessary to apply a certain amount of manual pressure to the tape upon bonding the tape to the curved surface. Otherwise, a separate tool should be used, causing inconvenience. The tape may also be likely to exhibit a degraded appearance due to its easy crumpling property. Such a conductive adhesive tape is usually used where conductivity is required, but no or low tensile strength is necessary. However, such a conductive adhesive tape is too thickly produced due to a large thickness of the metal foil, resulting in an increase in the production cost.

Another type of adhesive tape can be found in Korean Patent No. 10-0267814 that discloses a conductive adhesive tape comprising a synthetic resin film which is deposited with a metal layer on which a conductive adhesive is coated. However, this conductive adhesive tape suffers from being poor in conductivity. Korean Utility Laid-Open Publication No. 1998-065059 (the Korean '065059 patent) discloses a conductive adhesive tape based on a metal-plated woven net-shaped structure of polyester fiber which is coated with a conductive adhesive. However, the plating of metal to the net-shaped structure requires complicated processes.

For example, the process of plating the woven net-shaped fabric of polyester fiber with copper as diclosed in the Korean '065059 patent requires the steps of etching, neutralizing, activating, plating, and washing. Because of the rough surfaces and fine fibrous protuberances of the fabric, the desired metal layer cannot be properly deposited by a vacuum evaporation method as in the present invention. The film of the present invention maintains smoothness. Furthermore, the roughness of fabric creates impurities and increased wastewater during the processing, and these problems are avoided by the film of the present invention.

Therefore, it is an object of the invention to provide an electroconductive adhesive tape which is very thin, flexible and high in tensile strength in addition to showing excellent conductivity.

### BRIEF SUMMARY OF THE INVENTION

The present invention pertains to an electroconductive adhesive tape that comprises a synthetic resin film with circular or square perforations as seen in FIG. 4b or 4c, two metal plating layers deposited on both surfaces of the film, respectively, and a conductive adhesive layer formed on one of the metallic layers. The metal plating layers are formed on opposite sides of the perforated synthetic resin film, and a single conductive adhesive layer is formed on one of the surfaces of the metal plating layers.

### BRIEF DESCRIPTION OF THE SEVERAL VIEWS OF THE DRAWINGS

FIG. 1 is a diagrammatic illustration showing an electromagnetic wave shielding structure conventionally applied to a Braun tube in a side view.

FIG. 2 is a cross-sectional view illustrating a conventional electroconductive adhesive tape.

FIG. 3 is a plan view illustrating the process of forming metal plating layers on both surfaces of a perforated synthetic resin film.

FIG. 4a is a cross-sectional view illustrating an electroconductive adhesive tape of the present invention.

FIGS. 4b and 4c are diagrammatic illustrations of perforated synthetic resin films useful in the present invention.

FIG. 5 is a cross-sectional view illustrating an electroconductive adhesive tape (explosion-proof tape) employing a glass fiber net.

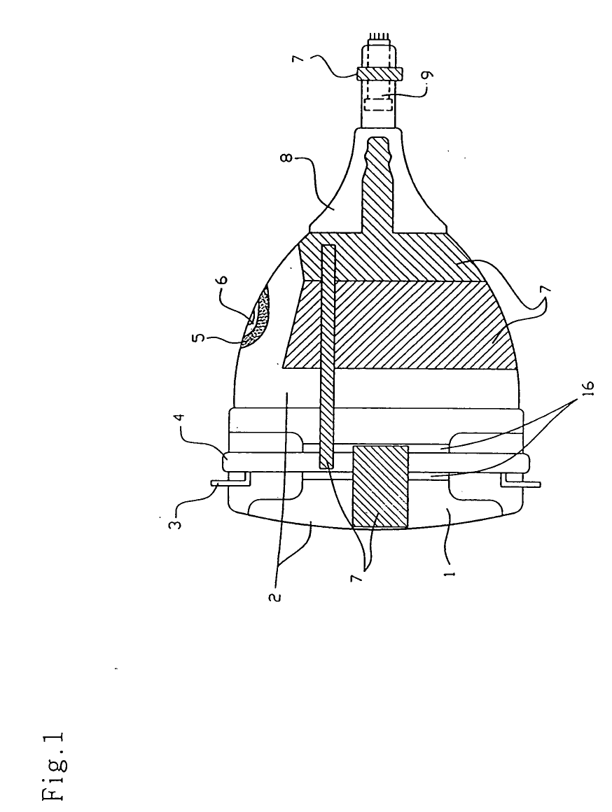

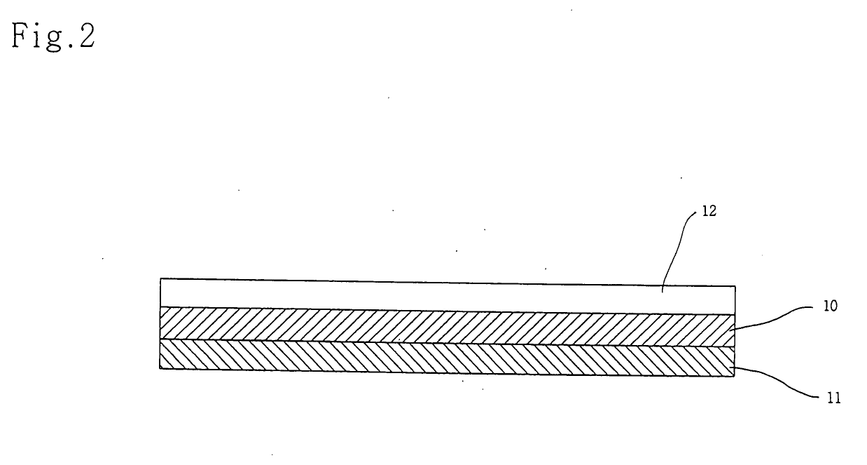

### DETAILED DESCRIPTION OF THE INVENTION

Exemplified by polyethylene, polypropylene, polyethylene terephthalate (hereinafter referred to as “PET”), and nylon, any synthetic resin film that is used as a base in conventional adhesive tapes may be used in the present invention. The synthetic resin film of the present invention is perforated. The synthetic resin film avoids rough surfaces and fine fibrous protuberances on a surface thereof. Any metal plating layers are connected through the perforated resin film

Metal useful for the plating layers may be selected from the group consisting of copper, aluminum, brass, tin, nickel, chromium, and silver.

As for the conductive adhesive, it may be a one which is well known in the art. For example, it is made by mixing 50-200 weight parts of a conductive powder 5 μm or smaller in size, selected from copper, nickel, chrome, and graphite, with 100 weight parts of an adhesive material.

In accordance with the present invention, the electroconductive tape has a thickness of 50-100 μm in total, in which the metal plating layer ranges from 1 to 5 μm in thickness while 20-65 μm is assigned to the synthetic resin film and 30-40 μm to the conductive adhesive layer.

The metal plating layer may be formed by use of a vacuum depositing, electrolysis metal plating, sputtering, ion plating, chemical vapor depositing, or physical vapor depositing method.

The conductive adhesive tape of the present invention is crumpled to a much lesser extent as compared to conventional conductive adhesive tapes including a well-known metal foil. It is also possible to allow the tape to have an optional color in accordance with the selection of an appropriate metal to be deposited. Furthermore, the coating of the conductive adhesive layer over the metal layer prevents oxidation from occurring at the surface of the metal layer with the passage of time, enjoying the advantage of no reduction in permittivity. In particular, the metal plating layers are integratedly formed through the perforations of the synthetic resin film, maintaining excellent electrical conductivity. The present will now be described in detail with reference to the following example, but the present invention is not to be construed as being limited thereto.

EXAMPLES

<Electroconductive Adhesive>

100 parts by weight of an acrylic adhesive with a solid content of 40% was homogeneously admixed with 50 parts by weight of a copper powder with a mean particle size of 5 μm to give a conductive adhesive. This adhesive is well known in the art.

<PET Film>

There was prepared a PET film 20 μm thick. The film was punched to form 4-20 holes per cm². Preferably, the holes ranged from 0.5 to 1.0 mm in size. The holes may be circular or square in shape.

<Preparation of Electroconductive Adhesive Tape>

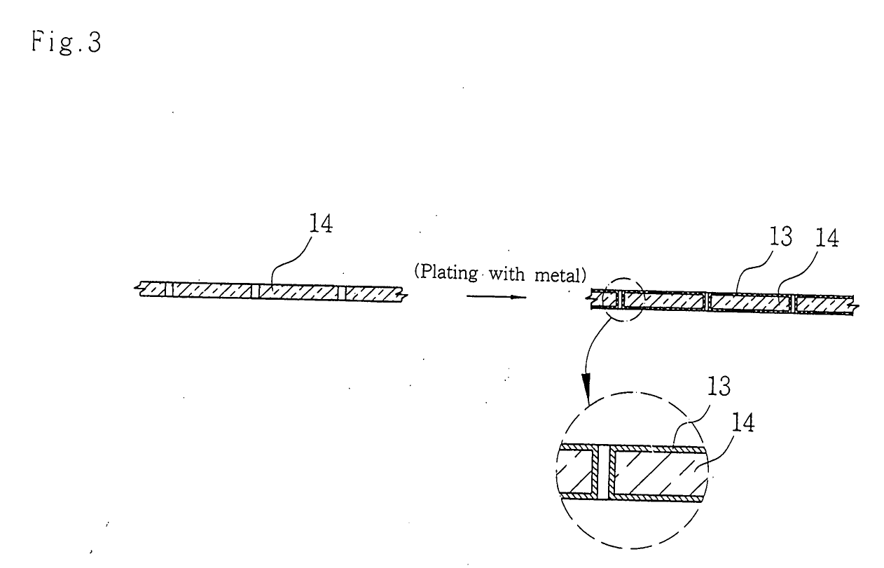

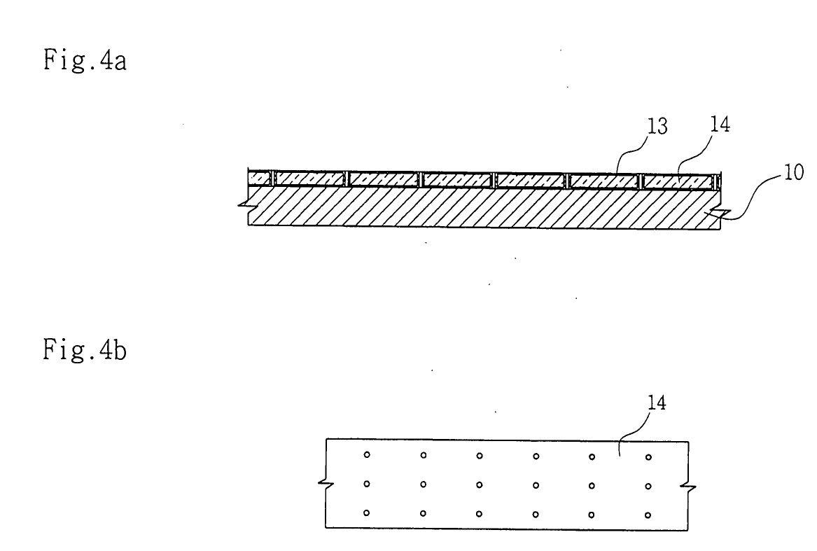

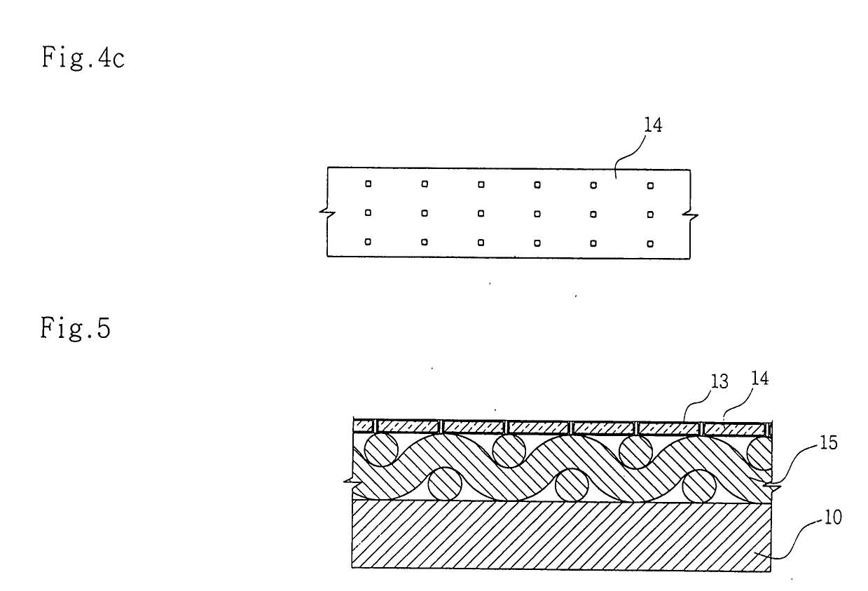

While being moved at a certain speed within a vacuum deposition bath, the perforated PE film was deposited with Al metal under an evaporation condition of the Al metal, as seen in FIG. 3.

The deposition of aluminum was carried out to a thickness of about 3 μm. The method for depositing metal such as aluminum over a synthetic resin film is well known in this technical field.

Thereafter, the conductive adhesive was coated to a thickness of about 30 μm over one surface of the Al-deposited PET film and then dried to afford an electroconductive adhesive tape. The overall thickness of the electroconductive adhesive tape is about 60 μm.

<Preparation of Explosion-Proof Tape>

Due to the requirement of high tensile strength, an explosion-proof tape employed a glass fiber net as a base.

On one surface of the metal plate layer-formed PET film obtained above, a glass fiber net was laid, followed by coating the conductive adhesive layer onto the glass fiber net. The explosion-proof tape was based on the fiber glass net and the synthetic resin film. Thus, fabric has a use in conductive adhesive tapes, but the present invention does not depend upon the tensile strength provided by the fabric in order to function as an explosion proof tape, and the glass fibers are not disclosed by the use of polyester fibers.

It is important to note that the Korean '065059 patent does not disclose the present invention because the woven polyester fiber of the Korean '065059 patent is a fabric and not a film. The prior art discloses a conductive adhesive tape based on a metal-plated woven net-shaped structure of polyester fiber which is coated with a conductive adhesive. However, there are inherent differences between a fabric and a film such that one skilled in the art would not consider that coated fabric to disclose a coated film. The plating of metal to the net-shaped structure requires complicated processes.

Additionally, the Korean '065059 patent discloses an electromagnetic shielding film wherein a shield pad 20, including a net-shaped polyester yarn having a pre-determined mesh size plated with copper, is adhered between two transparent polyester protective films 10 and 20 using an adhesive agent. Thus, this electromagnetic shielding film is thick with poor adhesiveness. Furthermore, as a fabric, the invention of the prior art cannot maintain a clear cut face when cut, such that the invention cannot be used for manufacturing electronic products and maintaining electroconductivity. The Korean '065059 patent also teaches against the present invention because a fabric of polyester fiber is not available for less than 100 μm in thickness. Thus, when an adhesive is applied to the net shaped fabric, the overall combination has a thickness ranging from 130 μm to 180 μm.

The electroconductive adhesive tape of the present invention can be made very thin and has the advantage of being flexible and high in tensile strength in addition to showing excellent electrical conductivity.

I claim:

1. An electroconductive adhesive tape comprising:
a perforated synthetic resin film;
a first metal plating layer formed on one side of said perforated synthetic resin film;
second metal plating layer formed on an opposite side of said perforated synthetic resin film; and
a conductive adhesive layer formed on a surface of one of said first and second metal plating layers opposite said perforated synthetic resin film, a combined thickness of said perforated synthetic resin film and said first and second metal plating layers and said conductive adhesive layer being no more than 100 μm.

2. The tape of claim 1, said perforated synthetic film being of a material selected from the group consisting of polyethylene, polyethylene terephthalate, polypropylene and nylon.

3. The tape of claim 1, each of said first and second metal plating layers selected from the group consisting of copper, aluminum, silver, brass, tin, nickel and chromium.

4. The tape of claim 1, further comprising:
a glass fiber net interposed between the metal plating layer and the conductive adhesive layer.
